(19) United States
(12) Patent Application Publication
(10) Pub. No.: US 2025/0079088 A1
(43) Pub. Date: Mar. 6, 2025

(54) MULTILAYER FEEDTHROUGH CAPACITOR

(71) Applicant: TDK Corporation, Tokyo (JP)

(72) Inventors: Toru ONOUE, Tokyo (JP); Masahiro Iwama, Tokyo (JP); Yutaro Arai, Tokyo (JP)

(73) Assignee: TDK Corporation, Tokyo (JP)

(21) Appl. No.: 18/773,891

(22) Filed: Jul. 16, 2024

(30) Foreign Application Priority Data
Aug. 30, 2023 (JP) 2023-139719

(51) Int. Cl. H01G 4/35; H01G 4/012; H01G 4/232; H01G 4/30

(52) U.S. Cl. CPC H01G 4/35; H01G 4/012; H01G 4/232; H01G 4/30

(57) ABSTRACT

A multilayer feedthrough capacitor includes an element body, a pair of first external electrodes, a second external electrode, and a plurality of internal electrodes. The plurality of internal electrodes include at least one first internal electrode connected to the pair of first external electrodes, at least one second internal electrode connected to the pair of first external electrodes, and at least one third internal electrode connected to the second external electrode. The at least one first internal electrode is connected to the pair of first external electrodes with a first connection width, and the at least one second internal electrode is connected to the pair of first external electrodes with a second connection width larger than the first connection width.

### CROSS-REFERENCE TO RELATED APPLICATIONS

This application is based upon and claims the benefit of priority from Japanese Patent Application No. 2023-139719, filed on Aug. 30, 2023. The entire contents of which are incorporated herein by reference.

### BACKGROUND

### Field

The present disclosure relates to a multilayer feedthrough capacitor.

### Description of the Related Art

Known multilayer feedthrough capacitors include an element body, a pair of first external electrodes disposed on the element body and separated from each other, a second external electrode disposed on the element body and separated from the pair of first external electrodes, and a plurality of internal electrodes disposed in the element body (for example, refer to Japanese Unexamined Patent Publication No. 2018-67562). The plurality of internal electrodes include one internal electrode connected to the pair of first external electrodes and another internal electrode opposing the one internal electrode and connected to the second external electrode.

### SUMMARY

One aspect of the present disclosure provides a multilayer feedthrough capacitor that decreases direct current (DC) resistance and prevents a decrease in reliability.

A multilayer feedthrough capacitor according to one aspect of the present disclosure includes an element body, a pair of first external electrodes disposed on the element body and separated from each other, a second external electrode disposed on the element body and separated from the pair of first external electrodes, and a plurality of internal electrodes disposed in the element body. The plurality of internal electrodes include at least one first internal electrode connected to the pair of first external electrodes, at least one second internal electrode connected to the pair of first external electrodes, and at least one third internal electrode connected to the second external electrode. The element body includes a first region in which the at least one first internal electrode and the at least one third internal electrode are disposed and oppose each other and a second region in which the at least one second internal electrode is disposed. The at least one first internal electrode is connected to the pair of first external electrodes with a first connection width. The at least one second internal electrode is connected to the pair of first external electrodes with a second connection width larger than the first connection width.

In the one aspect, the at least one first internal electrode and the at least one second internal electrode are independently connected to the pair of first external electrodes. The at least one second internal electrode is disposed in the second region different from the first region in which the at least one first internal electrode and the at least one third internal electrode are disposed and oppose each other. The at least one second internal electrode, therefore, contributes to decreasing the DC resistance.

In the one aspect, the second connection width is larger than the first connection width. A connection length between each of the first external electrodes and the at least one second internal electrode is larger than the connection length between each of the first external electrodes and the at least one first internal electrode. A current, therefore, tends to flow to the at least one second internal electrode. The at least one second internal electrode further contributes to decreasing the DC resistance.

As a result, the one aspect decreases the DC resistance.

In various electronic components such as the multilayer feedthrough capacitors, an external electrode tends to include a plating layer and an underlying layer for forming the plating layer in order to improve mountability. The plating layer is formed through, for example, electroplating. When the plating layer is formed through electroplating, a plating solution may reach an interface between the underlying layer and the element body and then enter the element body. An entry of the plating solution into the element body may decrease reliability of the various electronic components. Entry paths of the plating solution into the element body include, for example, an interface between a connection end of an internal electrode with an external electrode and the element body.

In the one aspect, the second connection width is larger than the first connection width. The first connection width is smaller than the second connection width. A length of a connection end of the at least one first internal electrode with each of the pair of first external electrodes is smaller than a length of the connection end of the at least one second internal electrode with each of the pair of first external electrodes. Therefore, the plating solution tends not to enter the element body from an interface between the connection end of the at least one first internal electrode and the element body. As a result, the one aspect prevents the decrease in reliability.

In the one aspect, the plurality of internal electrodes may include at least one fourth internal electrode connected to the pair of first external electrodes and at least one fifth internal electrode connected to the second external electrode. The element body may include a third region in which the at least one fourth internal electrode and the at least one fifth internal electrode are disposed to oppose each other. The at least one fourth internal electrode is connected to the pair of first external electrodes with a third connection width smaller than the second connection width. The second region may be positioned between the first region and the third region.

In a configuration where the third connection width is smaller than the second connection width, the connection length between each of the first external electrodes and the at least one second internal electrode is larger than the connection length between each of the first external electrodes and the at least one fourth internal electrode. A current, therefore, tends to flow to the at least one second internal electrode. The at least one second internal electrode further contributes to decreasing the DC resistance. As a result, this configuration further decreases the DC resistance.

In a configuration where the third connection width is smaller than the second connection width, a length of the connection end of the at least one fourth internal electrode with each of the pair of first external electrodes is smaller than the length of the connection end of the at least one second internal electrode with each of the pair of first external electrodes. Therefore, the plating solution tend not to enter the element body from an interface between the connection end of the at least one fourth internal electrode and the element body. As a result, this configuration prevents a reduction in reliability.

The element body may have a shape in which ridges of the element body are curved or chamfered. In a configuration where the element body has the shape, a thickness of the underlying layer tends to be small at the ridges of the element body. In a configuration where the thickness of the underlying layer is small, the plating solution tends to reach the interface between the underlying layer and the element body through the underlying layer. At an interface between a connection end of an internal electrode close to the ridge of the element body with an external electrode and the element body, therefore, the plating solution tends to enter, as compared with an interface between a connection end of an internal electrode far from the ridge of the element body with an external electrode and the element body.

In a configuration where the second region is positioned between the first region and the third region, the first region and the third region tend to be close to ridges of the element body, as compared with the second region. The plating solution may tend to enter the first region and the third region, as compared with the second region. In a configuration where the first connection width is smaller than the second connection width and the third connection width is smaller than the second connection width, however, the plating solution tend not to enter the element body. Even in the configuration where the second region is positioned between the first region and the third region, therefore, the decrease in reliability can be prevented.

In the one aspect, the at least one fourth internal electrode may include an electrode region opposing the at least one fifth internal electrode and having a width larger than the third connection width.

A configuration where the at least one fourth internal electrode includes the electrode region tends to increase an area where the at least one fourth internal electrode and the at least one fifth internal electrode oppose each other. This configuration, therefore, can increase capacitance.

In the one aspect, the at least one second internal electrode may include a plurality of second internal electrodes opposing each other with an interval smaller than the interval between the at least one fourth internal electrode and the at least one fifth internal electrode.

A configuration where the plurality of second internal electrodes oppose each other with the interval smaller than the interval between the at least one fourth internal electrode and the at least one fifth internal electrode can increase the number of second internal electrodes disposed in the second region. This configuration, therefore, can further decrease the DC resistance.

The configuration where the plurality of second internal electrodes oppose each other with the interval smaller than the interval between the at least one fourth internal electrode and the at least one fifth internal electrode can increase the interval between the at least one fourth internal electrode and the at least one fifth internal electrode. This configuration, therefore, prevents a short circuit between the at least one fourth internal electrode and the at least one fifth internal electrode.

In the one aspect, the at least one first internal electrode may include an electrode region opposing the at least one third internal electrode and having a width larger than the first connection width.

A configuration where the at least one first internal electrode includes the electrode region tends to increase an area where the at least one first internal electrode and the at least one third internal electrode oppose each other. This configuration, therefore, can increase capacitance.

In the one aspect, the at least one second internal electrode may include a plurality of second internal electrodes opposing each other with an interval smaller than the interval between the at least one first internal electrode and the at least one third internal electrode.

A configuration where the plurality of second internal electrodes oppose each other with the interval smaller than the interval between the at least one first internal electrode and the at least one third internal electrode can increase the number of second internal electrodes disposed in the second region. This configuration, therefore, can further decrease the DC resistance.

The configuration where the plurality of second internal electrodes oppose each other with the interval smaller than the interval between the at least one first internal electrode and the at least one third internal electrode can increase the interval between the at least one first internal electrode and the at least one third internal electrode. This configuration, therefore, prevents a short circuit between the at least one first internal electrode and the at least one third internal electrode.

In the one aspect, the plurality of internal electrodes may include at least one sixth internal electrode connected to the pair of first external electrodes. The element body may include a fourth region in which the at least one sixth internal electrode is disposed. The at least one sixth internal electrode may be connected to the pair of first external electrodes with a fourth connection width larger than the first connection width. The first region may be positioned between the second region and the fourth region.

In a configuration where the plurality of internal electrodes include the at least one sixth internal electrode, the at least one first internal electrode and the at least one second internal electrode are independently connected to the pair of first external electrodes. The at least one sixth internal electrode is disposed in the fourth region different from the first region in which the at least one first internal electrode and the at least one third internal electrode are disposed to oppose each other. The at least one sixth internal electrode, therefore, further contributes to decreasing the DC resistance. In a configuration where the fourth connection width is larger than the first connection width, a connection length between each of the first external electrodes and the at least one sixth internal electrode is larger than the connection length between each of the first external electrodes and the at least one first internal electrode. A current, therefore, tends to flow to the at least one sixth internal electrode. The at least one sixth internal electrode contributes to decreasing the DC resistance. As a result, these configurations further decrease the DC resistance.

In the configuration where the first connection width is smaller than the fourth connection width, the length of the connection end of the at least one first internal electrode with each of the pair of first external electrodes is smaller than length of a connection end of the at least one sixth internal electrode with each of the pair of first external electrodes. Therefore, the plating solution tend not to enter the element body from an interface between the connection end of the at least one first internal electrode and the element body. As a result, this configuration prevents the decrease in reliability.

In the one aspect, the at least one first internal electrode may include a plurality of first internal electrodes having different first connection widths.

In a configuration where the at least one first internal electrode includes a plurality of first internal electrodes having different first connection widths, the first connection width of each of the plurality of first internal electrodes is smaller than the second connection width. Therefore, the plating solution tend not to enter the element body from an interface between the connection end of each of the plurality of first internal electrodes and the element body. As a result, this configuration still prevents the decrease in reliability.

The present disclosure will become more fully understood from the detailed description given hereinafter and the accompanying drawings which are given by way of illustration only, and thus are not to be considered as limiting the present disclosure.

Further scope of applicability of the present disclosure will become apparent from the detailed description given hereinafter. However, it should be understood that the detailed description and specific examples, while indicating examples of the disclosure, are given by way of illustration only, since various changes and modifications within the spirit and scope of the disclosure will become apparent to those skilled in the art from this detailed description.

### BRIEF DESCRIPTION OF THE DRAWINGS

FIG. 1 is a perspective view illustrating a multilayer feedthrough capacitor according to an example;

FIG. 2 is an exploded perspective view illustrating an element body and a plurality of internal electrodes;

FIG. 3 is a diagram illustrating a cross-sectional configuration of the multilayer feedthrough capacitor according to the example;

FIG. 4 is a diagram illustrating a cross-sectional configuration of the multilayer feedthrough capacitor according to the example;

FIG. 5 is a plan view illustrating an internal electrode;

FIG. 6 is a plan view illustrating an internal electrode;

FIG. 7 is a plan view illustrating an internal electrode;

FIG. 8 is a plan view illustrating an internal electrode;

FIG. 9 is a plan view illustrating an internal electrode;

FIG. 10 is an exploded perspective view illustrating an element body and a plurality of other internal electrodes;

FIG. 11 is a plan view illustrating an internal electrode;

FIG. 12 is an exploded perspective view illustrating an element body and a plurality of other internal electrodes;

FIG. 13 is an exploded perspective view illustrating an element body and a plurality of other internal electrodes;

FIG. 14 is a plan view illustrating an internal electrode; and

FIG. 15 is a plan view illustrating an internal electrode.

### DETAILED DESCRIPTION

Hereinafter, examples of the present disclosure will be described in detail with reference to the accompanying drawings. In the following description, the same elements or elements having the same functions are denoted with the same reference numerals and overlapped explanation is omitted.

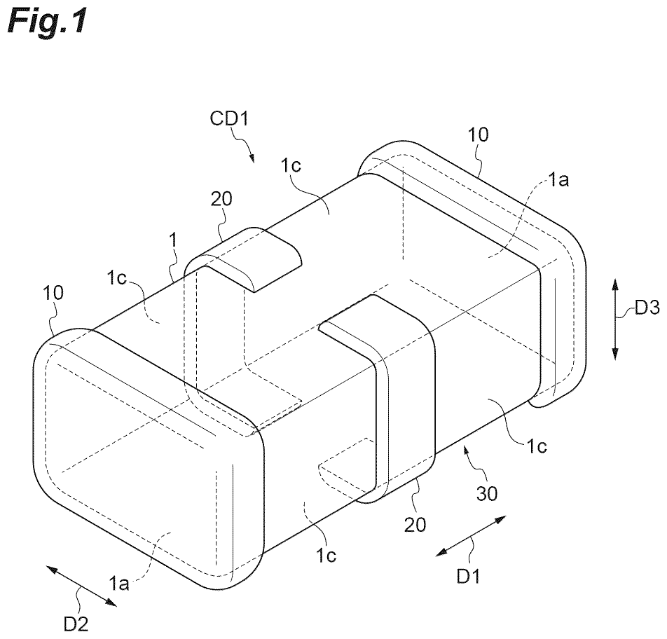

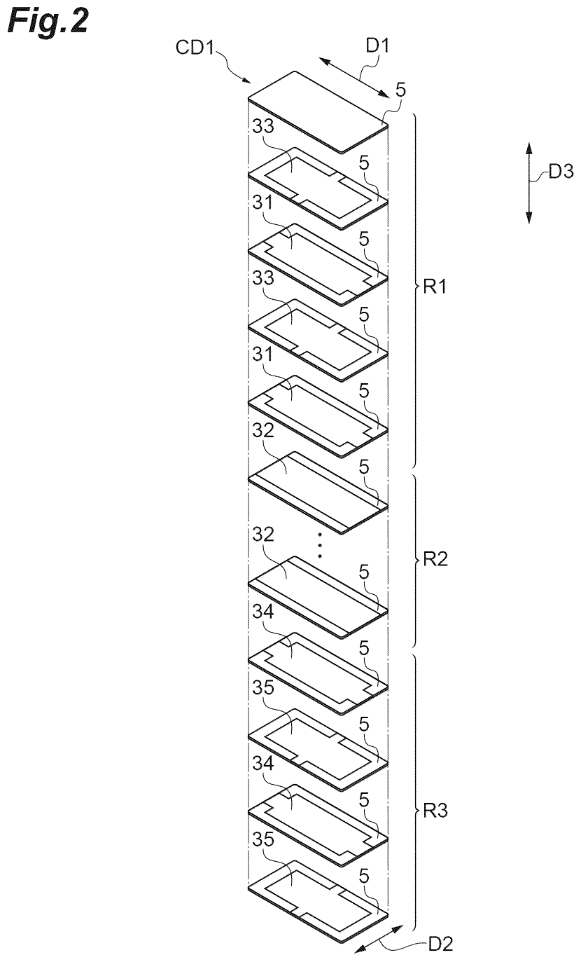

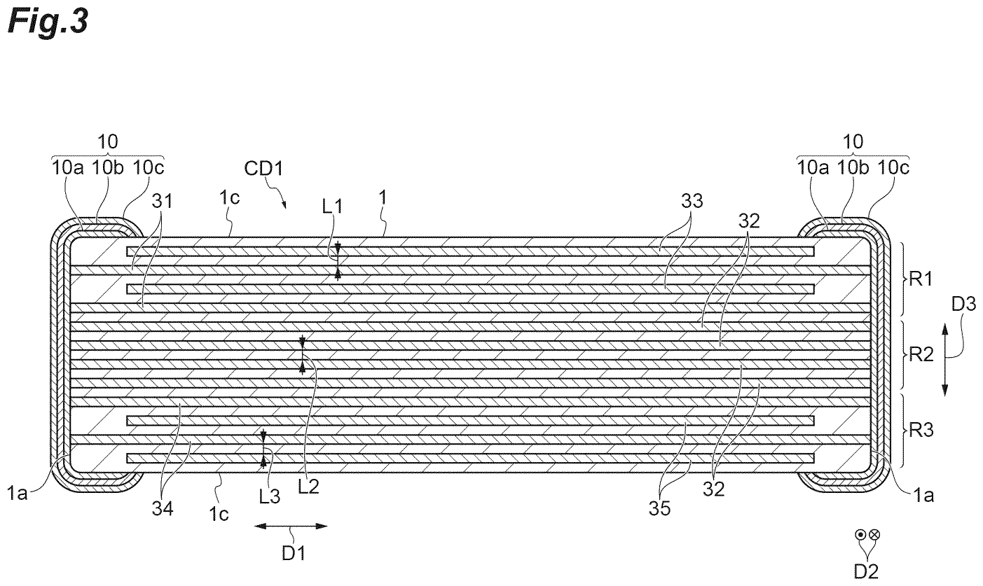

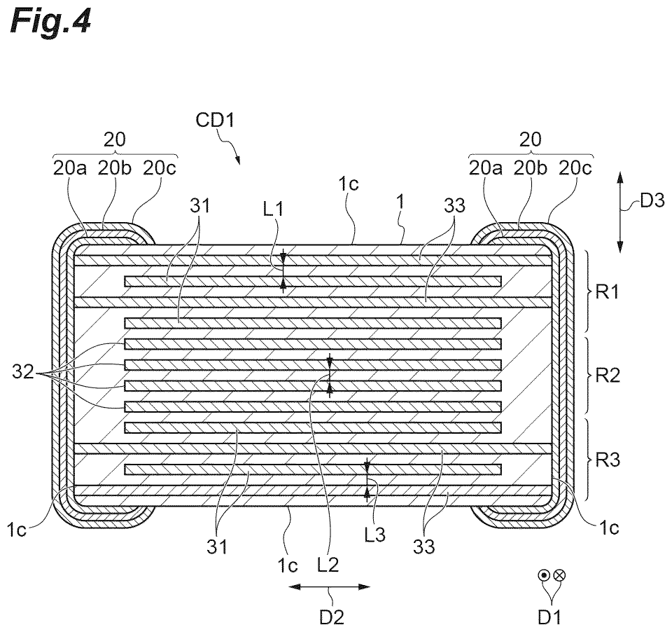

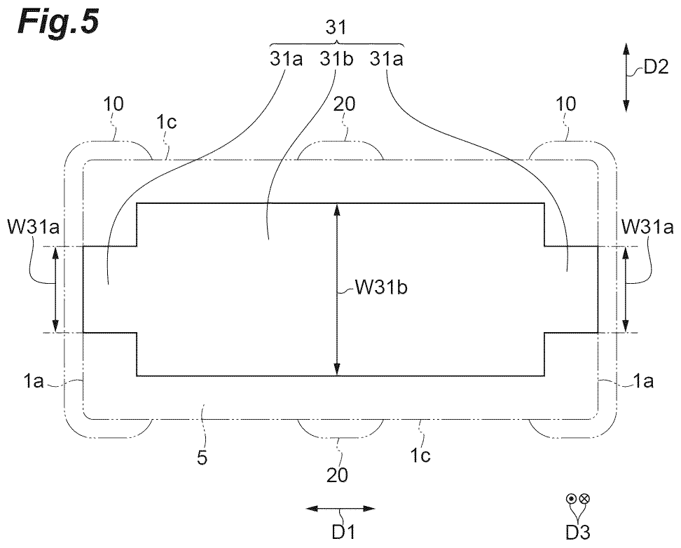

A configuration of a multilayer feedthrough capacitor CD1 according to an example will be described with reference to FIGS. 1 to 9. FIG. 1 is a perspective view illustrating the multilayer feedthrough capacitor according to the example. FIG. 2 is an exploded perspective view illustrating an element body and a plurality of internal electrodes. FIGS. 3 and 4 are diagrams illustrating a cross-sectional configuration of the multilayer feedthrough capacitor according to the example. Each of FIGS. 5 to 9 is a plan view illustrating an internal electrode.

As illustrated in FIGS. 1 to 4, the multilayer feedthrough capacitor CD1 includes an element body 1, a pair of external electrodes 10, an external electrode 20, and a plurality of internal electrodes 30. The pair of external electrodes 10 are disposed on the element body 1 to be separated from each other. External electrodes 20 are disposed on the element body 1 to be separated from the pair of external electrodes 10. The plurality of internal electrodes 30 are disposed in the element body 1.

The element body 1 has a rectangular parallelepiped shape. For example, the rectangular parallelepiped shape includes the rectangular parallelepiped shape in which corners and ridges are chamfered, or the rectangular parallelepiped shape in which corners and ridges are rounded. The element body 1 includes a pair of end surfaces 1a opposing each other and four side surfaces 1c coupling the pair of end surfaces 1a. An outer surface of the element body 1 includes the pair of end surfaces 1a and the four side surfaces 1c. Each of the pair of end surfaces 1a and the four side surfaces 1c has a rectangular shape. The rectangular shape includes, for example, a shape in which each corner is chamfered or a shape in which each corner is rounded. In FIG. 1, illustration of the plurality of internal electrodes 30 is omitted.

The element body 1 includes a plurality of dielectric layers 5. Each dielectric layer 5 is laminated in a third direction D3. Each dielectric layer 5 includes a sintered body of a ceramic green sheet including a dielectric material. The dielectric material includes, for example, a BaTiO₃-based, Ba (Ti, Zr) O₃-based, or (Ba, Ca) TiO₃-based dielectric ceramic. The dielectric layers 5 are integrated together to such an extent that boundaries between the dielectric layers 5 cannot be visually recognized.

The pair of end surfaces 1a oppose each other in a first direction D1. A pair of side surfaces 1c of the four side surfaces 1c oppose each other in a second direction D2. Another pair of side surfaces 1c oppose each other in the third direction D3. The four side surfaces 1c extend in the first direction D1 to couple the pair of end surfaces 1a. The first direction D1 intersects the second direction D2 and intersects the third direction D3. The second direction D2 intersects the third direction D3. For example, the first direction D1, the second direction D2, and the third direction D3 are orthogonal to each other.

A length of the element body 1 in the first direction D1 is, for example, 0.8 to 3.4 mm. A length of the element body 1 in the second direction D2 is, for example, 0.3 to 1.8 mm. A length of the element body 1 in the third direction D3 is, for example, 0.3 to 1.8 mm. In the element body 1, for example, the first direction D1 includes a longitudinal direction.

Each of the pair of external electrodes 10 is disposed on both a corresponding end surface 1a of the pair of end surfaces 1a and the four side surfaces 1c. Each of the external electrodes 10 includes a first electrode portion positioned on the corresponding end surface 1a and a second electrode portion positioned on a part of each of the four side surfaces 1c. The first electrode portion is continuous with the second electrode portion. The second electrode portion covers regions of the side surfaces 1c near the corresponding end surface 1a. The pair of external electrodes 10 includes a signal external electrode.

The external electrodes 20 are disposed on the pair of side surfaces 1c. The multilayer feedthrough capacitor CD1 may include a pair of external electrodes 20. FIG. 1 illustrates an example where the multilayer feedthrough capacitor CD1 includes the pair of external electrodes 20. Each of the pair of external electrodes 20 is disposed on a corresponding side surface 1c of the pair of side surfaces 1c. For example, the pair of external electrodes 20 are separated from each other and oppose each other in the second direction D2. The multilayer feedthrough capacitor CD1 may include only one external electrode 20. In a configuration where the multilayer feedthrough capacitor CD1 includes only one external electrode 20, for example, the external electrode 20 is disposed of first side surface 1c. The external electrodes 20 include a ground external electrode. When the external electrode 10 includes a first external electrode, the external electrodes 20 includes a second external electrode.

As illustrated in FIGS. 3 and 4, the external electrode 10 includes an underlying layer 10a. The external electrode 20 includes an underlying layer 20a. The underlying layers 10a and 20a include a sintered metal layer. The sintered metal layer is formed through applying a conductive paste to the outer surface of the element body 1 and sintering the paste. The conductive paste includes a metal powder, a glass component, an organic binder, and an organic solvent. The metal powder included in the conductive paste includes, for example, a Cu powder or a Ni powder. The underlying layers 10a and 20a include a layer obtained through sintering the metal powder included in the conductive paste. The external electrode 10 includes at least one plating layer on the underlying layer 10a. The external electrode 20 includes at least one plating layer on the underlying layer 20a. The external electrodes 10 include two plating layers 10b and 10c on the underlying layer 10a, and the external electrodes 20 include two plating layers 20b and 20c on the underlying layer 20a. The underlying layer 10a includes an underlying layer for forming the plating layer 10b. The underlying layer 20a includes an underlying layer for forming the plating layer 20b. The plating layer 10b is positioned between the underlying layer 10a and the plating layer 10c. The plating layer 20b is positioned between the underlying layer 20a and the plating layer 20c. The plating layers 10b and 20b include, for example, a Ni plating layer. The plating layers 10b and 20b may include a Sn plating layer, a Cu plating layer, or a Au plating layer instead of the Ni plating layer. The plating layers 10c and 20c include a solder plating layer. The solder plating layer includes a Sn plating layer, a Sn—Ag alloy plating layer, a Sn—Bi alloy plating layer, or a Sn—Cu alloy plating layer. These plating layers are formed by plating methods. The plating methods include, for example, electroplating.

As illustrated in FIGS. 2 to 4, the element body 1 includes a region R1, a region R2, and a region R3. The region R1 and the region R3 in which a signal internal electrode and a ground internal electrode are disposed mainly contribute to forming a capacitance of the multilayer feedthrough capacitor CD1. The region R2 includes an energization internal electrode, and mainly contributes to decreasing the DC resistance (Rdc) of the multilayer feedthrough capacitor CD1. The region R2 is disposed between the region R1 and the region R3. The region R2 is disposed between the region R1 and the region R3 in the third direction D3. When the region R1 includes a first region, the region R2 includes a second region, and the region R3 includes a third region.

In the region R1, a plurality of internal electrodes 31 and a plurality of internal electrodes 33 are disposed. At least one internal electrode 31 and at least one internal electrode 33 are disposed in the region R1. The plurality of internal electrodes 30 include the internal electrodes 31 and the internal electrodes 33. The plurality of internal electrodes 30 include the plurality of internal electrodes 31 and the plurality of internal electrodes 33. The plurality of internal electrodes 30 include at least one internal electrode 31 and at least one internal electrode 33. The internal electrodes 31 include the signal internal electrode. The internal electrodes 33 include the ground internal electrode. As illustrated in FIGS. 2 to 4, each internal electrode 31 and each internal electrode 33 oppose each other with one of the dielectric layers 5 interposed therebetween. Each internal electrode 31 and each internal electrode 33 oppose each other with an interval L1. The internal electrodes 31 and the internal electrodes 33 are alternately disposed. When the internal electrodes 31 include a first internal electrode, the internal electrode 33 includes a third internal electrode.

As illustrated in FIG. 5, the internal electrode 31 extends in the first direction D1 and is exposed to the pair of end surfaces 1a. The internal electrode 31 is connected to the pair of external electrodes 10. The internal electrode 31 is electrically connected to the pair of external electrodes 10. The internal electrode 31 is separated from the side surfaces 1c without being exposed to the side surfaces 1c. The internal electrode 31 is not connected to the external electrodes 20.

The internal electrode 31 includes a connection region 31a and an electrode region 31b. The internal electrode 31 includes two connection regions 31a and one electrode region 31b. The one electrode region 31b is positioned between the two connection regions 31a in the first direction D1. The two connection regions 31a and the one electrode region 31b are continuous with each other. The connection region 31a and the electrode region 31b have, for example, a rectangular shape when viewed in the third direction D3. When the connection region 31a includes a first connection region, for example, the electrode region 31b includes a first electrode region.

Each of the two connection regions 31a is connected to a corresponding external electrode 10 of the pair of external electrodes 10. Each of the connection regions 31a and the corresponding external electrode 10 are connected to each other. Each of the connection regions 31a is connected to the corresponding external electrode 10 with a connection width W31a. The connection width W31a is a length of a connection end of the at least one internal electrode 31 with each of the pair of external electrodes 10. The connection width W31a has, for example, the same length as a width of the connection regions 31a in the second direction D2. The electrode region 31b has a width W31b in the second direction D2. The connection width W31a is, for example, smaller than the width W31b. The connection width W31a may be smaller than or equal to the width W31b. The connection width W31a may be the same as the width W31b. The width of the connection region 31a in the second direction D2 may be the same as the width of the electrode region 31b in the second direction D2. FIGS. 2 and 5 illustrate an example where the connection width W31a is smaller than the width W31b. The at least one internal electrode 31 includes the plurality of internal electrodes 31 having different connection widths W31a. Each of the plurality of internal electrodes 31 has, for example, a different connection width W31a.

When widths are “the same” herein, the widths may be equal to each other or widths including a slight difference within a predetermined range or a making error may be equal to each other. When an average of connection widths W31a falls within a range of +10% from an average value of widths W31b, for example, the connection widths W31a are determined to be the same as the widths W31b.

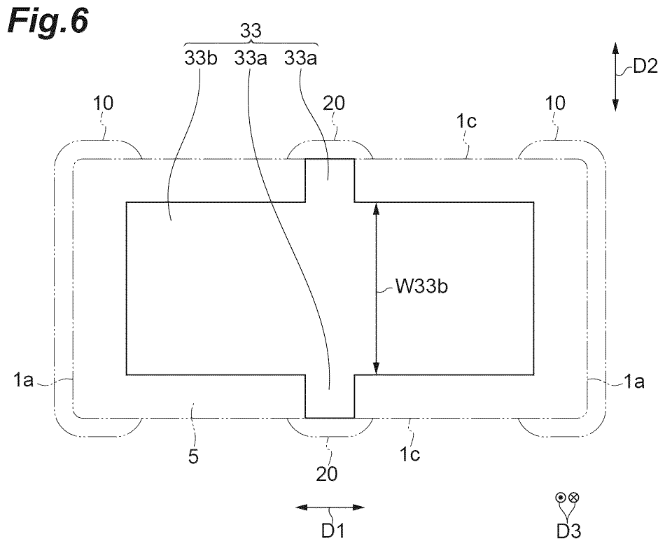

As illustrated in FIG. 6, the internal electrode 33 extends in the second direction D2 and is exposed to at least one of the pair of side surfaces 1c. The internal electrode 33 is connected to the external electrodes 20. The internal electrode 33 is exposed to the pair of side surfaces 1c and connected at the pair of external electrodes 20. The internal electrode 33 is electrically connected to the external electrodes 20. The internal electrode 33 is separated from the end surfaces 1a without being exposed to the end surfaces 1a. The internal electrodes 33 are not connected to the external electrodes 10. The at least one internal electrode 33 opposes the electrode region 31b.

The internal electrode 33 includes a connection region 33a and an electrode region 33b. The internal electrode 33 includes two connection regions 33a and one electrode region 33b. The one electrode region 33b is positioned between the two connection regions 33a in the second direction D2. The two connection regions 33a and the one electrode region 33b are continuous with each other. The connection regions 33a and the electrode region 33b have, for example, a rectangular shape when viewed in the third direction D3. When the connection region 33a includes a third connection region, for example, the electrode region 33b includes a third electrode region.

Each of the two connection regions 33a is connected to a corresponding external electrode 20 of the pair of external electrodes 20. The connection regions 33a are electrically connected to the corresponding external electrodes 20. The width of the connection regions 33a in the first direction D1 is smaller than the width of the electrode region 33b in the first direction D1. The electrode region 33b has a width W33b in the second direction D2. The width W33b is, for example, the same as the width W31b. The width W33b may be larger than the connection width W31a. The width W33b may be larger than or equal to the connection width W31a.

In the region R2, a plurality of internal electrodes 32 are disposed. At least one internal electrode 32 is disposed in the region R2. The plurality of internal electrodes 30 include the internal electrodes 32. In the region R2, the at least one internal electrode 32 is disposed. The at least one internal electrode 32 includes the plurality of internal electrodes 32. The internal electrodes 32 include the energization internal electrode. As illustrated in FIGS. 2 to 4, the plurality of internal electrodes 32 oppose each other with one of the dielectric layers 5 interposed therebetween. The plurality of internal electrodes 32 oppose each other with an interval L2. Internal electrodes 34 and internal electrodes 35 are alternately disposed. The interval L2 is, for example, smaller than the interval L1. The at least one internal electrode 32, therefore, opposes the at least one internal electrode 31 with the interval L2 that is smaller than the interval L1 between the at least one internal electrode 31 and the at least one internal electrode 33. The plurality of internal electrodes 32 may include an internal electrode 32 opposing one of the internal electrodes 33. In a configuration where the plurality of internal electrodes 32 includes the internal electrode 32 opposing one of the internal electrodes 33, the plurality of internal electrodes 32 necessarily include an internal electrode 32 that does not oppose any of the internal electrodes 33. When the internal electrode 31 includes a first internal electrode, for example, the internal electrode 32 includes a second internal electrode.

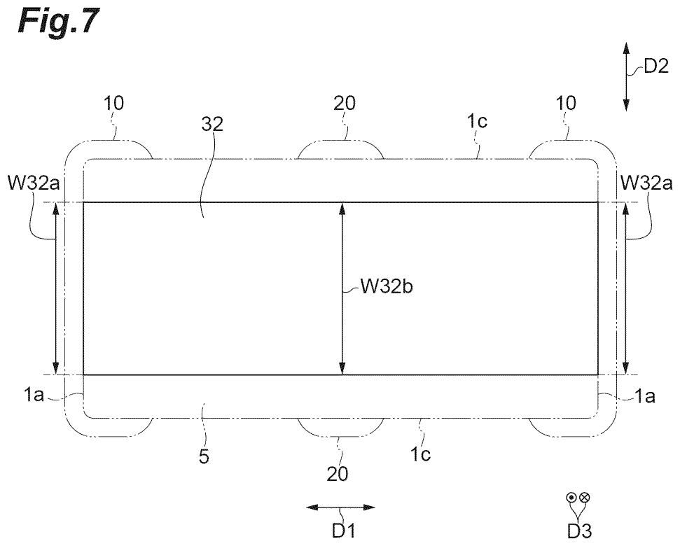

As illustrated in FIG. 7, the internal electrode 32 extends in the first direction D1 and is exposed to the pair of end surfaces 1a. The internal electrode 32 is connected to the pair of external electrodes 10. The internal electrode 32 is electrically connected to the pair of external electrodes 10. The internal electrode 32 is separated from the side surfaces 1c without being exposed to the side surfaces 1c. The internal electrode 32 is not connected to the external electrodes 20. The internal electrode 32 has, for example, a rectangular shape when viewed in the third direction D3.

The internal electrode 32 is connected to the pair of external electrodes 10 with a connection width W32a. The connection width W32a is length of a connection end of the at least one internal electrode 32 with each of the pair of external electrodes 10. The internal electrode 32 has a width W32b in the second direction D2. The connection width W32a is, for example, the same as the width W32b. The width W32b is, for example, the same as the width W31b. The width W32b may be larger than the width W31b. When the connection width W31a includes a first connection width, for example, the connection width W32a includes a second connection width.

The width W32b is the same as the connection width W32a, the width W31b, and the width W33b, and is larger than the connection width W31a. The width W32b may be the same as the connection width W32a. The width W32b may be larger than the width W31b and be larger than the width W33b. The width W31b and the width W33b may be larger than or equal to the connection width W31a.

In the region R3, a plurality of internal electrodes 34 and a plurality of internal electrodes 35 are disposed. At least one internal electrode 34 and at least one internal electrode 35 are disposed in the region R3. The plurality of internal electrodes 30 include the internal electrodes 34 and the internal electrodes 35. The internal electrode 34 includes the signal internal electrode. The internal electrode 35 includes the ground internal electrode. As illustrated in FIGS. 2 to 4, each internal electrode 34 and each internal electrode 35 oppose each other with one of the dielectric layers 5 interposed therebetween. Each internal electrode 34 and each internal electrode 35 oppose each other with an interval L3. Internal electrodes 34 and internal electrodes 35 are alternately disposed. The interval L2 is, for example, smaller than the interval L3. The at least one internal electrode 32, therefore, opposes each other with the interval L2 that is smaller than the interval L3 between the at least one internal electrode 34 and the at least one internal electrode 35. The plurality of internal electrodes 32 may include an internal electrode 32 opposing one of the internal electrodes 35. In a configuration where the plurality of internal electrodes 32 includes the internal electrode 32 opposing one of the internal electrodes 35, the plurality of internal electrodes 32 necessarily include an internal electrode 32 that does not oppose any of the internal electrodes 35. When the internal electrodes 31 include a first internal electrode, for example, the internal electrodes 34 include a fourth internal electrode, and the internal electrodes 35 include a fifth internal electrode.

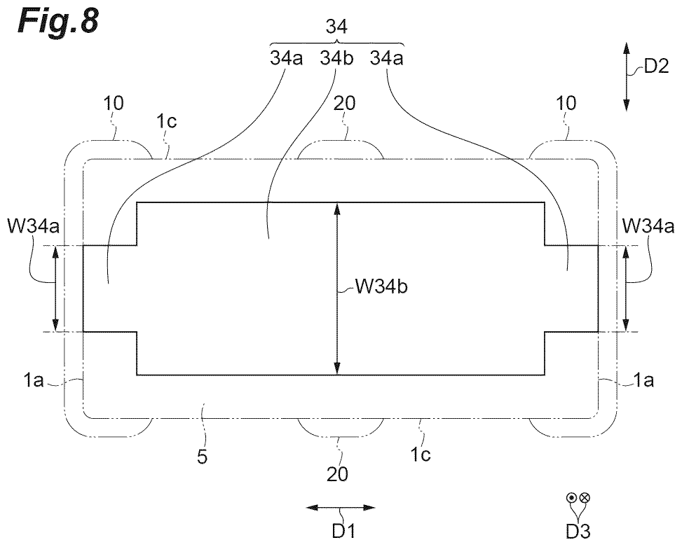

As illustrated in FIG. 8, the internal electrode 34 extends in the first direction D1 and is exposed to the pair of end surfaces 1a. The internal electrode 34 is connected to the pair of external electrodes 10. The internal electrode 34 is electrically connected to the pair of external electrodes 10. The internal electrode 34 is separated from the side surfaces 1c without being exposed to the side surfaces 1c. The internal electrode 34 is not connected to the external electrodes 20.

The internal electrode 34 includes a plurality of connection regions 34a and an electrode region 34b. The internal electrode 34 includes two connection regions 34a and one electrode region 34b. The one electrode region 34b is positioned between the two connection regions 34a in the first direction D1. The two connection regions 34a and the one electrode region 34b are continuous with each other. The connection regions 34a and the electrode region 34b have, for example, a rectangular shape when viewed in the third direction D3. When the connection region 34a includes a fourth connection region, for example, the electrode region 34b includes a fourth electrode region.

Each of the two connection regions 34a is connected to a corresponding external electrode 10 of the pair of external electrodes 10. Each of the connection regions 34a and the corresponding external electrode 10 are connected to each other. Each of the connection regions 34a is connected to the corresponding external electrode 10 with a connection width W34a. The connection width W34a is a length of a connection end of the at least one internal electrode 34 with each of the pair of external electrodes 10. The connection width W34a is, for example, the same as the width of the connection regions 34a in the second direction D2. The electrode region 34b has a width W34b in the second direction D2. The connection width W34a is, for example, smaller than the width W34b. The connection width W34a may be smaller than or equal to the width W34b. The connection width W34a may be the same as the width W34b. The width of the connection regions 34a in the second direction D2 may be the same as the width of the electrode region 34b in the second direction D2. FIGS. 2 and 8 illustrate an example where the connection width W34a is smaller than the width W34b. When the connection width W31a includes a first connection width, for example, the connection width W34a includes a third connection width.

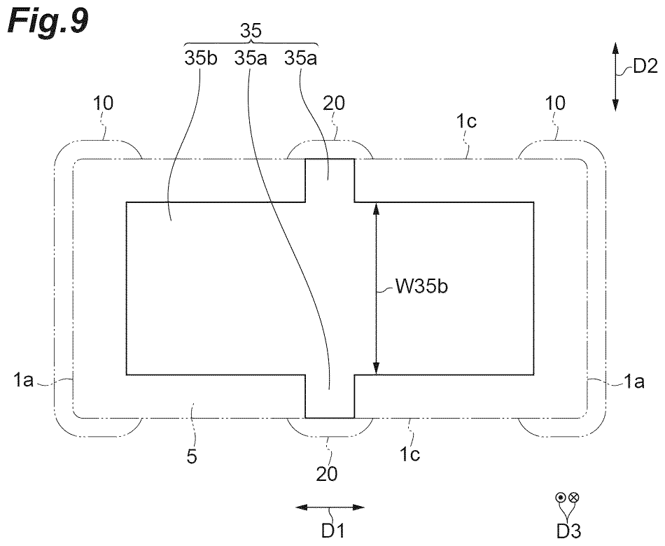

As illustrated in FIG. 9, the internal electrode 35 extends in the second direction D2 and are exposed to at least one of the pair of side surfaces 1c. The internal electrode 35 is connected to the external electrodes 20. The internal electrode 35 is exposed to the pair of side surfaces 1c and connected to the pair of external electrodes 20. The internal electrode 35 is electrically connected to the external electrodes 20. The internal electrode 35 is separated from the end surfaces 1a without being exposed to the end surfaces 1a. The internal electrode 35 is not connected to the external electrodes 10. The at least one internal electrode 35 opposes the electrode region 34b.

The internal electrode 35 includes connection regions 35a and an electrode region 35b. The internal electrode 35 includes two connection regions 35a and one electrode region 35b. The one electrode region 35b is positioned between the two connection regions 35a in the second direction D2. The two connection regions 35a and the one electrode region 35b are continuous with each other. The connection regions 35a and the electrode region 35b have, for example, a rectangular shape when viewed in the third direction D3. When the connection region 35a includes fifth connection regions, for example, the electrode region 35b includes a fifth electrode region.

Each of the two connection regions 35a is connected to a corresponding external electrode 20 of the pair of external electrodes 20. The connection regions 35a are electrically connected to the corresponding external electrodes 20. The width of the connection regions 35a in the first direction D1 is smaller than the width of the electrode region 35b in the first direction D1.

The electrode region 35b has a width W35b in the second direction D2. The width W35b is, for example, the same as the width W31b. The width W35b may be larger than the connection width W31a. The width W35b may be larger than or equal to the connection width W31a. The width W35b is, for example, the same as the width W34b. The width W35b may be larger than the connection width W34a. The width W35b may be larger than or equal to the connection width W34a.

Each of the two connection regions 35a is connected to a corresponding external electrode 20 of the pair of external electrodes 20. The connection region 35a is electrically connected to the corresponding external electrode 20. The width of the connection regions 35a in the first direction D1 is smaller than the width of the electrode region 35b in the first direction D1.

The plurality of internal electrodes 30 include a conductive material that is usually used for internal electrodes of a multilayer electrical component. The conductive material included in the plurality of internal electrodes 30 includes Ni or Cu. The plurality of internal electrodes 30 are configured as a sintered body of a conductive paste including the conductive material.

In the example illustrated in FIGS. 3 and 4, the region R1 includes two internal electrodes 31 and two internal electrodes 33, and the total number of internal electrodes included in the region R1 is four. The region R2 includes four internal electrodes 32, and the total number of internal electrodes included in the region R2 is four. The total number of internal electrodes included in the region R2 is the same as the total number of internal electrodes included in the region R1. The example is not limited to a configuration where the total number of internal electrodes included in the region R2 is the same as the total number of internal electrodes included in the region R1. The example is not limited to a configuration the number of dielectric layers 5 included in the region R2 is the same as the number of dielectric layers 5 included in the region R1.

As described above, the interval L2 is, for example, smaller than the interval L1. When the interval L2 is smaller than the interval L1, thickness of each dielectric layer 5 included in the region R2 is smaller than thickness of each dielectric layer 5 included in the region R1. The thickness of each dielectric layer 5 included in the region R2 is, for example, about 1/10 to ½ of the thickness of each dielectric layer 5 included in the region R1. The number of dielectric layers 5 included in the region R2, therefore, may be larger than the number of dielectric layers 5 included in the region R1. The total number of internal electrodes included in the region R2 may be larger than the total number of internal electrodes included in the region R1.

In the example, the number of dielectric layers 5 included in the region R2 may be 10 to 500. The number of dielectric layers 5 included in the region R1 may be 3 to 300.

In the example illustrated in FIGS. 3 and 4, the region R3 includes two internal electrodes 34 and two internal electrodes 35, and the total number of internal electrodes included in the region R3 is four. The total number of internal electrodes included in the region R2 is the same as the total number of internal electrodes included in the region R3. The example is not limited to a configuration where the total number of internal electrodes included in the region R2 is the same as the total number of internal electrodes included in the region R3. The example is not limited to a configuration where the number of dielectric layers 5 included in the region R2 is the same as the number of dielectric layers 5 included in the region R3.

As described above, the interval L2 is, for example, smaller than the interval L3. When the interval L2 is smaller than the interval L3, the thickness of each dielectric layer 5 included in the region R2 is smaller than thickness of each dielectric layer 5 included in the region R3. The thickness of each dielectric layer 5 included in the region R2 is, for example, about 1/10 to ½ of the thickness of each dielectric layer 5 included in the region R3. The number of dielectric layers 5 included in the region R2, therefore, may be larger than the number of dielectric layers 5 included in the region R3. The total number of internal electrodes included in the region R2 may be larger than the total number of internal electrodes included in the region R3.

In the example, the number of dielectric layers 5 included in the region R3 may be 3 to 300.

The multilayer feedthrough capacitor CD1 is mounted on an electronic device. The electronic device includes a circuit board or an electronic component. For example, the multilayer feedthrough capacitor CD1 is solder-mounted on the electronic device. In the multilayer feedthrough capacitor CD1, one of the side surfaces 1c includes a mounting surface opposing the electronic device.

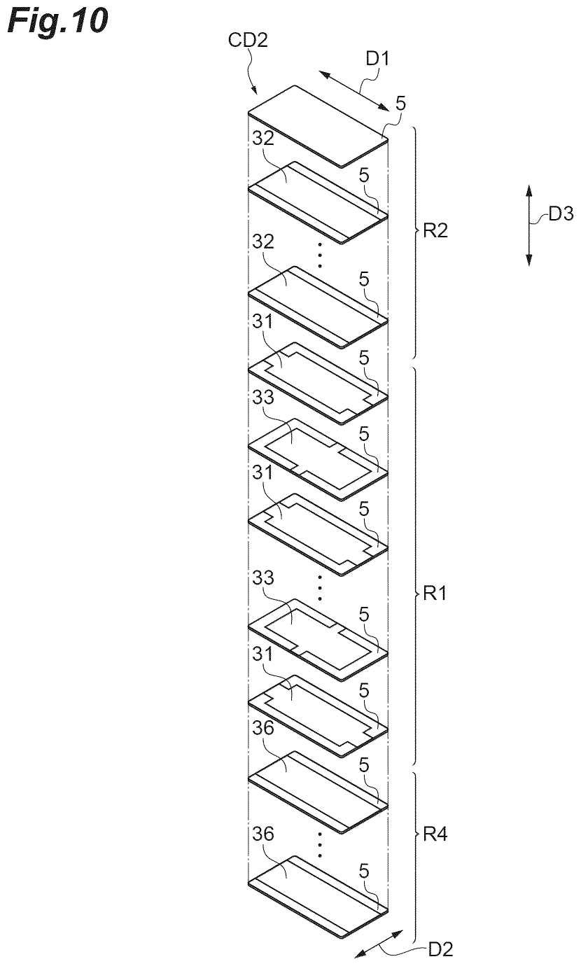

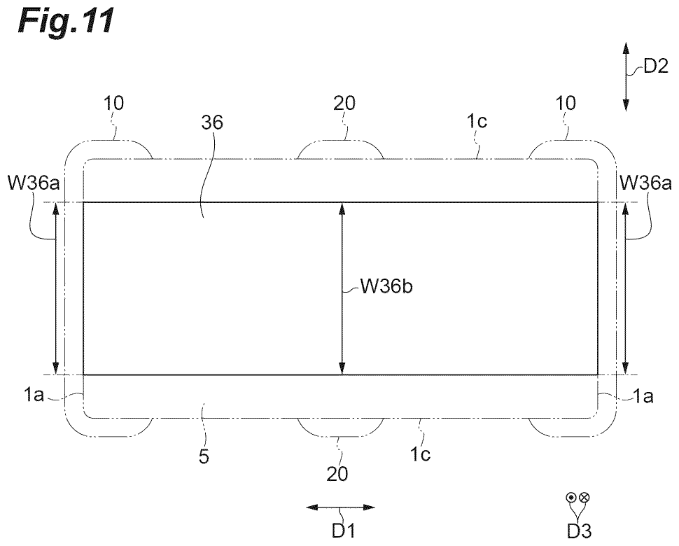

A multilayer feedthrough capacitor CD2 according to a one modification of the example will be described with reference to FIGS. 10 and 11. FIG. 10 is an exploded perspective view illustrating another element body and a plurality of other internal electrodes. FIG. 11 is a plan view illustrating another internal electrode. The multilayer feedthrough capacitor CD2 is generally similar to or the same as the multilayer feedthrough capacitor CD1, but the multilayer feedthrough capacitor CD2 is different from the multilayer feedthrough capacitor CD1 in terms of the element body 1 and the internal electrodes 30. Differences between the multilayer feedthrough capacitor CD1 and the multilayer feedthrough capacitor CD2 will be mainly described hereinafter.

As illustrated in FIG. 10, in the one modification, the element body 1 includes a region R1, a region R2, and a region R4. The region R1 is positioned between the region R2 and the region R4. In the example, the region R1 is disposed between the region R2 and the region R4 in the third direction D3. When the region R1 includes a first region, for example, the region R4 includes a fourth region.

In the region R4, a plurality of internal electrodes 36 are disposed. At least one internal electrode 36 is disposed in the region R4. The plurality of internal electrodes 30 include the internal electrodes 36. In the region R4, at least one internal electrode 36 is disposed. The internal electrode 36 includes the energization internal electrode. When the internal electrode 31 includes a first internal electrode, for example, the internal electrode 36 includes a sixth internal electrode.

As illustrated in FIG. 11, the internal electrode 36 extends in the first direction D1 and is exposed to the pair of end surfaces 1a. The internal electrode 36 is connected to the pair of external electrodes 10. The internal electrode 36 is electrically connected to the pair of external electrodes 10. The internal electrode 36 is separated from the side surfaces 1c without being exposed to the side surfaces 1c. The internal electrode 36 is not connected to the external electrodes 20. The internal electrode 36 has, for example, a rectangular shape when viewed in the third direction D3.

The internal electrode 36 is connected to the pair of external electrodes 10 with a connection width W36a. The connection width W36a is a length of a connection end of the at least one internal electrode 36 with each of the pair of external electrodes 10. The internal electrode 36 has a width W36b in the second direction D2. The connection width W36a is, for example, the same as the width W36b. The width W36b is, for example, the same as the width W31b. The width W36b may be larger than the width W31b. When the connection width W31a includes a first connection width, for example, the connection width W36a includes a fourth connection width.

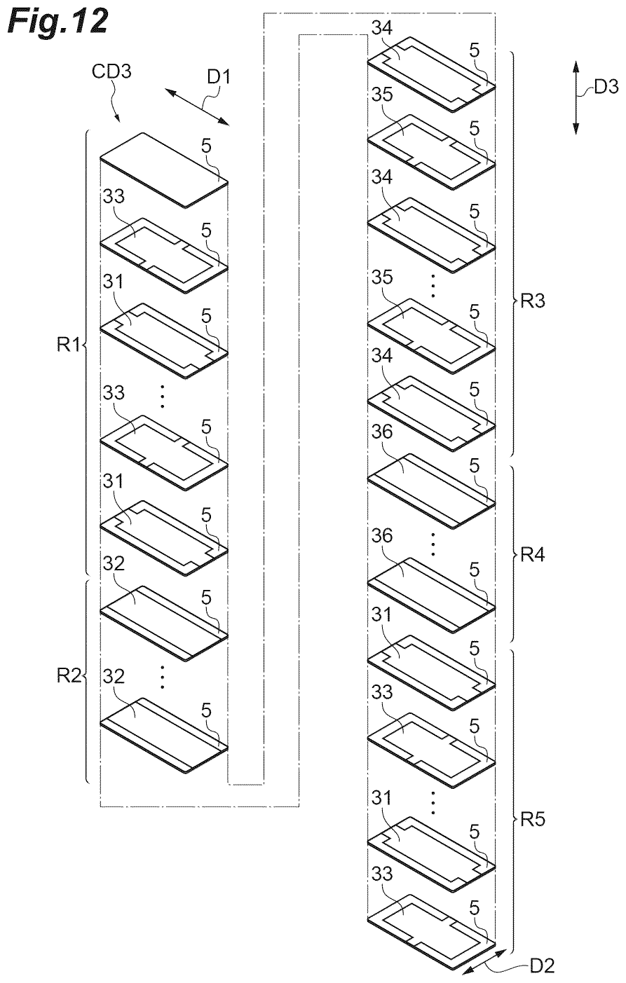

A multilayer feedthrough capacitor CD3 according to another modification of the example will be described with reference to FIG. 12. FIG. 12 is an exploded perspective view illustrating another element body and a plurality of other internal electrodes. The multilayer feedthrough capacitor CD3 is generally similar to or the same as the multilayer feedthrough capacitor CD1, but the multilayer feedthrough capacitor CD3 is different from the multilayer feedthrough capacitor CD1 in terms of the element body 1 and the plurality of internal electrodes 30. Differences between the multilayer feedthrough capacitor CD1 and the multilayer feedthrough capacitor CD3 will be mainly described hereinafter.

In the other modification, the element body 1 includes a region R1, a region R2, a region R3, a region R4, and a region R5. In the region R5, a plurality of internal electrodes 31 and a plurality of internal electrodes 33 are disposed. At least one internal electrode 31 and at least one internal electrode 33 are disposed in the region R5. Each internal electrode 31 and each internal electrode 33 oppose each other with one of the dielectric layers 5 interposed therebetween. The internal electrodes 31 and the internal electrodes 33 are alternately disposed. In the other modification, the region R1, the region R2, the region R3, the region R4, and the region R5 are disposed in order of the region R1, the region R2, the region R3, the region R4, and the region R5 in the third direction D3. In the other modification, the connection width W31a is smaller than the width W31b, and the connection width W34a is smaller than the width W34b.

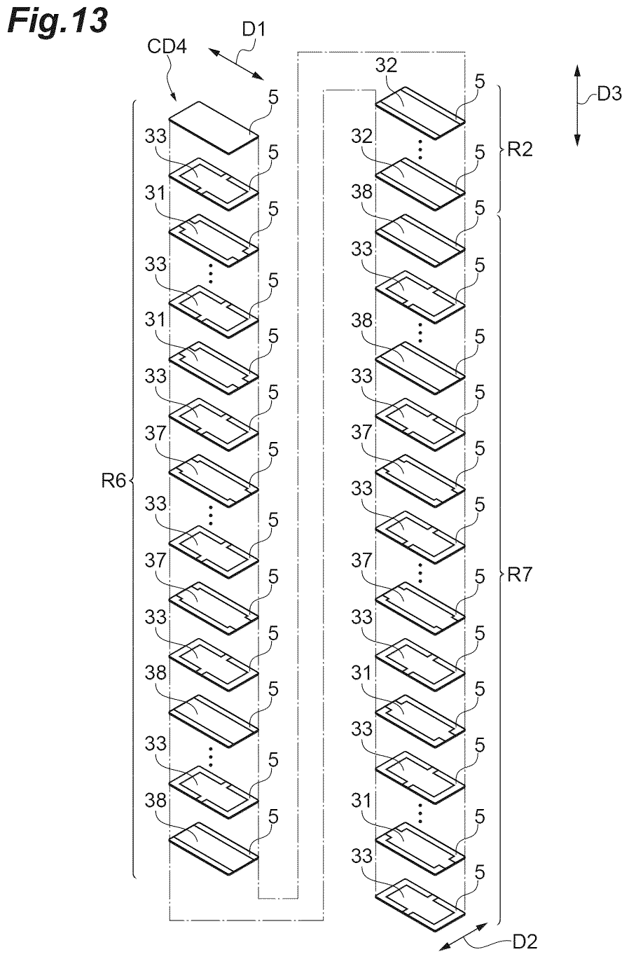

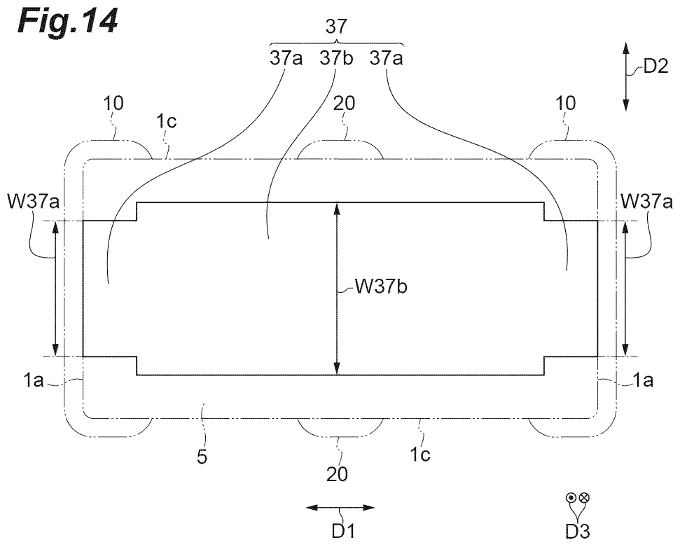

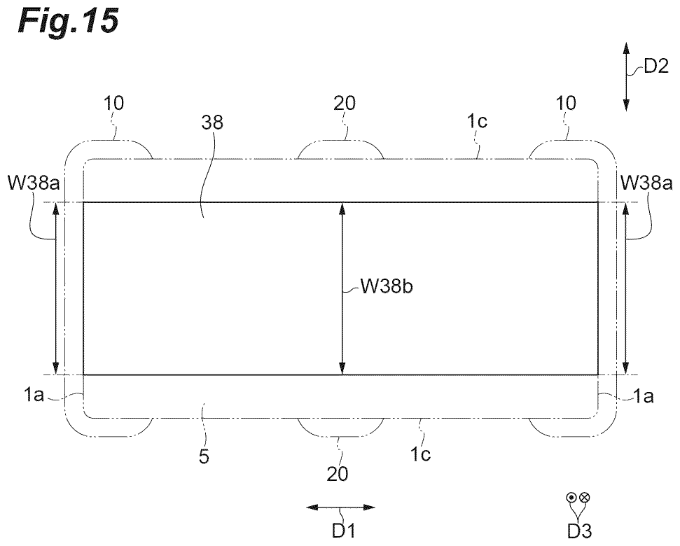

A multilayer feedthrough capacitor CD4 according to still another modification of the example will be described with reference to FIGS. 13 to 15. FIG. 13 is an exploded perspective view illustrating another element body and a plurality of other internal electrodes. FIGS. 14 and 15 are plan views illustrating the internal electrodes. The multilayer feedthrough capacitor CD4 is generally similar to or the same as the multilayer feedthrough capacitor CD1, but the multilayer feedthrough capacitor CD4 is different from the multilayer feedthrough capacitor CD1 in terms of the element body 1 and the plurality of internal electrodes 30. Differences between the multilayer feedthrough capacitor CD1 and the multilayer feedthrough capacitor CD4 will be mainly described hereinafter.

In the still another modification, the element body 1 includes a region R2, a region R6, and a region R7. The region R2, the region R6, and the region R7 are disposed in order of the region R6, the region R2, and the region R7 in the third direction D3. The region R2 includes at least one internal electrode 32. In the region R2, at least one internal electrode 32 is disposed.

In the region R6, a plurality of internal electrodes 31, a plurality of internal electrodes 33, a plurality of internal electrodes 37, and a plurality of internal electrodes 38 are disposed. At least one internal electrode 31, at least one internal electrode 33, at least one internal electrode 37, and at least one internal electrode 38 are disposed in the region R6. The plurality of internal electrodes 30 include the internal electrodes 31, 33, 37, and 38. The internal electrodes 37 and 38 include the signal internal electrode. Each internal electrode 37 and each internal electrode 33 oppose each other with one of the dielectric layers 5 interposed therebetween. The internal electrodes 37 and the internal electrodes 33 are alternately disposed. Each internal electrode 38 and each internal electrode 33 oppose each other with one of the dielectric layers 5 interposed therebetween. The internal electrodes 38 and the internal electrodes 33 are alternately disposed. In the region R6, the internal electrodes 37 are disposed closer to the region R2 than the internal electrodes 31, and the internal electrodes 38 are disposed closer to the region R2 than the internal electrodes 37.

As illustrated in FIG. 14, the internal electrode 37 is connected to the pair of external electrodes 10. The internal electrode 37 includes two connection regions 37a and one electrode region 37b. The one electrode region 37b is positioned between the two connection regions 37a in the first direction D1. The connection regions 37a and the electrode region 37b have, for example, a rectangular shape when viewed in the third direction D3.

Each of the two connection regions 37a is connected to a corresponding external electrode 10 of the pair of external electrodes 10. Each of the connection regions 37a is connected to the corresponding external electrode 10 with a connection width W37a. The connection width W37a is, for example, the same as the width of the connection regions 37a in the second direction D2. The connection width W37a is larger than the connection width W31a and is smaller than the width W37b. The width W37b is, for example, the same as the width W31b.

As illustrated in FIG. 15, the internal electrode 38 is connected to the pair of external electrodes 10. The internal electrode 38 is connected to the pair of external electrodes 10 with a connection width W38a. The internal electrode 38 has a width W38b in the second direction D2. The connection width W38a is, for example, the same as the width W38b. The connection width W38a is larger than the connection width W37a. The width W38b is, for example, the same as the width W31b.

In the region R7, a plurality of internal electrodes 31, a plurality of internal electrodes 33, a plurality of internal electrodes 37, and a plurality of internal electrodes 38 are disposed. At least one internal electrode 31, at least one internal electrode 33, at least one internal electrode 37, and at least one internal electrode 38 are disposed in the region R7. Each internal electrode 37 and each internal electrode 33 oppose each other with one of the dielectric layers 5 interposed therebetween. The internal electrodes 37 and the internal electrodes 33 are alternately disposed. Each internal electrode 38 and each internal electrode 33 oppose each other with one of the dielectric layers 5 interposed therebetween. The internal electrodes 38 and the internal electrodes 33 are alternately disposed. In the region R7, the internal electrodes 37 are disposed closer to the region R2 than the internal electrodes 31, and the internal electrodes 38 are disposed closer to the region R2 than the internal electrodes 37.

As described above, in the multilayer feedthrough capacitors CD1, CD2, CD3, and CD4, the at least one internal electrode 31 and the at least one internal electrode 32 are independently connected to the pair of external electrodes 10. The at least one internal electrode 32 is disposed in the region R2 different from the region R1 in which the at least one internal electrode 31 and the at least one internal electrode 33 are disposed and oppose each other. The at least one internal electrode 32, therefore, contributes to decreasing the DC resistance.

In the multilayer feedthrough capacitors CD1, CD2, CD3, and CD4, the connection width W32a is larger than the connection width W31a. A connection length between each of the external electrodes 10 and the at least one internal electrode 32 is larger than the connection length between each of the external electrodes 10 and the at least one internal electrode 31. A current, therefore, tends to flow to the at least one internal electrode 32. The at least one internal electrode 32 further contributes to decreasing the DC resistance.

As a result, the multilayer feedthrough capacitors CD1, CD2, CD3, and CD4 decrease the DC resistance.

In the multilayer feedthrough capacitors CD1, CD2, CD3, and CD4, the connection width W32a is larger than the connection width W31a. The connection width W31a is smaller than the connection width W32a. The length of the connection end of the at least one internal electrode 31 with each of the pair of external electrodes 10 is smaller than the length of the connection end of the at least one internal electrode 32 with each of the pair of external electrodes 10. Therefore, the plating solution tend not to enter the element body 1 from an interface between the connection end of the at least one internal electrode 31 and the element body 1. As a result, the multilayer feedthrough capacitors CD1, CD2, CD3, and CD4 prevent the decrease in in reliability.

In the multilayer feedthrough capacitor CD1, the plurality of internal electrodes 30 include at least one internal electrode 34 connected to the pair of external electrodes 10 and at least one internal electrode 35 connected to the external electrode 20. The element body 1 includes a region R3 in which the at least one internal electrode 34 and the at least one internal electrode 35 are disposed to oppose each other. The at least one internal electrode 34 is connected to the pair of external electrodes 10 with the connection width W34a smaller than the connection width W32a. The region R2 is positioned between the region R1 and the region R3.

In the multilayer feedthrough capacitor CD1, a connection length between each of the external electrodes 10 and the at least one internal electrode 32 is larger than the connection length between each of the external electrodes 10 and the at least one internal electrode 34. A current, therefore, tends to flow to the at least one internal electrode 32. The at least one internal electrode 32 further contributes to decreasing the DC resistance. As a result, the multilayer feedthrough capacitor CD1 further decreases the DC resistance.

In the multilayer feedthrough capacitor CD1, the length of the connection end of the at least one internal electrode 34 with each of the pair of external electrodes 10 is smaller than the length of the connection end of the at least one internal electrode 32 with each of the pair of external electrodes 10. Therefore, the plating solution tend not to enter the element body 1 from an interface between the connection end of the at least one internal electrode 34 and the element body 1. As a result, the multilayer feedthrough capacitor CD1 prevents the decrease in reliability.

In the multilayer feedthrough capacitor CD1, the region R1 and the region R3 tend to be closer to the ridge of the element body 1 than the region R2. The plating solution may tend to enter the region R1 and the region R3, as compared with the region R2. In the multilayer feedthrough capacitor CD1, however, since the connection width W31a is smaller than the connection width W32a and the connection width W34a is smaller than the connection width W32a, the plating solution tend not to enter the element body 1 as described above. Even in a configuration where the region R2 is positioned between the region R1 and the region R3, therefore, the decrease in reliability can be prevented of.

In the multilayer feedthrough capacitor CD1, the at least one internal electrode 34 opposes the at least one internal electrode 35 and includes the electrode region 34b having a width larger than the connection width W34a.

The multilayer feedthrough capacitor CD1 tends to increase the area where the at least one internal electrode 34 and the at least one internal electrode 35 oppose each other. The multilayer feedthrough capacitor CD1, therefore, can increase the capacitance.

In the multilayer feedthrough capacitor CD1, the at least one internal electrode 32 includes a plurality of internal electrodes 32 opposing each other with the interval L2 smaller than the interval L3.

The multilayer feedthrough capacitor CD1 can increase the number of internal electrodes 32 disposed in the region R2. The multilayer feedthrough capacitor CD1, therefore, can further decrease the DC resistance.

The multilayer feedthrough capacitor CD1 can increase an interval between the at least one internal electrode 34 and the at least one internal electrode 35. The multilayer feedthrough capacitor CD1, therefore, prevents a short circuit between the at least one internal electrode 34 and the at least one internal electrode 35.

In the multilayer feedthrough capacitor CD1, the internal electrodes 31 each include the electrode region 31b opposing one of the internal electrodes 33 and having a width larger than the connection width W31a.

The multilayer feedthrough capacitor CD1 tends to increase the area where the at least one internal electrode 31 and the at least one internal electrode 33 oppose each other. The multilayer feedthrough capacitor CD1, therefore, can increase the capacitance.

In the multilayer feedthrough capacitor CD1, the at least one internal electrode 32 includes a plurality of internal electrodes 32 opposing each other with the interval L2 smaller than the interval L1.

The multilayer feedthrough capacitor CD1 can increase the number of internal electrodes 32 disposed in the region R2. The multilayer feedthrough capacitor CD1, therefore, can further decrease the DC resistance.

The multilayer feedthrough capacitor CD1 can increase the interval between the at least one internal electrode 31 and the at least one internal electrode 33. The multilayer feedthrough capacitor CD1, therefore, prevents a short circuit between the at least one internal electrode 31 and the at least one internal electrode 33.

In the multilayer feedthrough capacitor CD2, the plurality of internal electrodes 30 include at least one internal electrode 36 connected to the pair of external electrodes 10. The element body 1 includes the region R4 in which at least one internal electrode 36 is disposed. The connection width W31a is smaller than the connection width W36a between each of the pair of external electrodes 10 and the at least one internal electrode 36. The at least one internal electrode 36 is connected to the pair of external electrodes 10 with the connection width W36a larger than the connection width W31a. The region R1 is positioned between the region R2 and the region R4.

In the multilayer feedthrough capacitor CD2, the at least one internal electrode 31 and the at least one internal electrode 36 are independently connected to the pair of external electrodes 10. The at least one internal electrode 36 is disposed in the region R4 different from the region R1 in which the at least one internal electrode 31 and the at least one internal electrode 33 are disposed to oppose each other. The at least one internal electrode 36, therefore, contributes to decreasing the DC resistance. In the multilayer feedthrough capacitor CD2, the connection width W31a is smaller than the connection width W36a, and the connection length between each of the external electrodes 10 and the at least one internal electrode 36 is larger than the connection length between each of the external electrodes 10 and the at least one internal electrode 31. A current, therefore, tends to flow to the at least one internal electrode 36. The at least one internal electrode 36 further contributes to decreasing the DC resistance. As a result, the multilayer feedthrough capacitor CD2 further decreases the DC resistance.

In the multilayer feedthrough capacitor CD2, the length of the connection end of the at least one internal electrode 31 with each of the pair of external electrodes 10 is smaller than the length of the connection end of the at least one internal electrode 36 with each of the pair of external electrodes 10. Therefore, the plating solution tend not to enter the element body 1 from an interface between the connection end of the at least one internal electrode 31 and the element body 1. As a result, the multilayer feedthrough capacitor CD2 prevents the decrease in reliability.

In the multilayer feedthrough capacitor CD1, the at least one internal electrode 31 includes the plurality of internal electrodes 31 having different connection widths W31a.

In the multilayer feedthrough capacitor CD1, even in a configuration where each of the plurality of internal electrodes 31 has a different connection width W31a, the connection width W31a of each of the plurality of internal electrodes 31 is smaller than the connection width W32a. Therefore, the plating solution tend not to enter the element body 1 from an interface between the connection end of each of the plurality of internal electrodes 31 and the element body 1. As a result, the multilayer feedthrough capacitor CD1 still prevents the decrease in reliability.

Although an example and modifications of the present disclosure have been described above, the present disclosure is not necessarily limited to the above-described example and modifications, and various alterations can be made without departing from the gist thereof.

The at least one internal electrode 34 may not include the electrode region 34b opposing the at least one internal electrode 35 and having a width larger than the connection width W34a. As described above, the configuration where the at least one internal electrode 34 includes the electrode region 34b opposing the at least one internal electrode 35 and having a width larger than the connection width W34a tends to increase the area where the at least one internal electrode 34 and the at least one internal electrode 35 oppose each other. Therefore, the capacitance can be increased.

The at least one internal electrode 31 may not include the electrode region 31b opposing the at least one internal electrode 33 and having a width larger than the connection width W31a. As described above, the configuration where the at least one internal electrode 31 includes the electrode region 31b opposing the at least one internal electrode 33 and having a width larger than the connection width W31a tends to increase the area where the at least one internal electrode 31 and the at least one internal electrode 33 oppose each other. Therefore, the capacitance can be increased.

In the multilayer feedthrough capacitor CD1, the at least one internal electrode 32 may not include a plurality of internal electrodes 32 opposing each other with the interval L2 smaller than the interval L3. The configuration where the at least one internal electrode 32 includes the plurality of internal electrodes 32 opposing each other with the interval L2 smaller than the interval L3 can increase the number of internal electrodes 32 disposed in the region R2 as described above. The multilayer feedthrough capacitor CD1, therefore, can further decrease the DC resistance. The multilayer feedthrough capacitor CD1 can increase the interval between the at least one internal electrode 34 and the at least one internal electrode 35. Therefore, a short circuit between the at least one internal electrode 34 and the at least one internal electrode 35 can be prevented.

The at least one internal electrode 32 may not include the plurality of internal electrodes 32 opposing each other with the interval L2 smaller than the interval L1. The configuration where the at least one internal electrode 32 includes the plurality of internal electrodes 32 opposing each other with the interval L2 smaller than the interval L1 can increase the number of internal electrodes 32 disposed in the region R2 as described above. The multilayer feedthrough capacitor CD1, therefore, can further decrease the DC resistance. The multilayer feedthrough capacitor CD1 can increase the interval between the at least one internal electrode 31 and the at least one internal electrode 33. Therefore, a short circuit between the at least one internal electrode 31 and the at least one internal electrode 33 can be prevented.

What is claimed is:

1. A multilayer feedthrough capacitor comprising:
an element body;
a pair of first external electrodes disposed on the element body and separated from each other;
a second external electrode disposed on the element body and separated from the pair of first external electrodes; and
a plurality of internal electrodes disposed in the element body,
wherein the plurality of internal electrodes include at least one first internal electrode connected to the pair of first external electrodes, at least one second internal electrode connected to the pair of first external electrodes, and at least one third internal electrode connected to the second external electrode,
the element body includes
a first region in which the at least one first internal electrode and the at least one third internal electrode are disposed and oppose each other, and
a second region in which the at least one second internal electrode is disposed,
the at least one first internal electrode is connected to the pair of first external electrodes with a first connection width, and
the at least one second internal electrode is connected to the pair of first external electrodes with a second connection width larger than the first connection width.

2. The multilayer feedthrough capacitor according to claim 1,
wherein the plurality of internal electrodes further include at least one fourth internal electrode connected to the pair of first external electrodes and at least one fifth internal electrode connected to the second external electrode,
the element body further includes a third region in which the at least one fourth internal electrode and the at least one fifth internal electrode are disposed to oppose each other,
the at least one fourth internal electrode is connected to the pair of first external electrodes with a third connection width smaller than the second connection width, and
the second region is positioned between the first region and the third region.

3. The multilayer feedthrough capacitor according to claim 2,
wherein the at least one fourth internal electrode includes an electrode region opposing the at least one fifth internal electrode and having a width larger than the third connection width.

4. The multilayer feedthrough capacitor according to claim 2,
wherein the at least one second internal electrode includes a plurality of second internal electrodes opposing each other with an interval smaller than the interval between the at least one fourth internal electrode and the at least one fifth internal electrode.

5. The multilayer feedthrough capacitor according to claim 1,
wherein the at least one first internal electrode includes an electrode region opposing the at least one third internal electrode and having a width larger than the first connection width.

6. The multilayer feedthrough capacitor according to claim 1,
wherein the at least one second internal electrode includes a plurality of second internal electrodes opposing each other with an interval smaller than the interval between the at least one first internal electrode and the at least one third internal electrode.

7. The multilayer feedthrough capacitor according to claim 1,
wherein the plurality of internal electrodes further include at least one sixth internal electrode connected to the pair of first external electrodes,
the element body further includes a fourth region in which the at least one sixth internal electrode is disposed,
the at least one sixth internal electrode is connected to the pair of first external electrodes with a fourth connection width larger than the first connection width, and
the first region is positioned between the second region and the fourth region.

8. The multilayer feedthrough capacitor according to claim 1,
wherein the at least one first internal electrode includes a plurality of first internal electrodes having different first connection widths.

9. The multilayer feedthrough capacitor according to claim 2,
wherein the element body includes first and second side surfaces opposing each other,
the first region is positioned at an outermost position of the first side surface in a direction in which the pair of side surfaces opposes each other, and
the third region is positioned at an outermost position of the second side surface in the direction in which the first and second side surfaces oppose each other.

10. The multilayer feedthrough capacitor according to claim 7,
wherein the element body includes first and second side surfaces opposing each other,
the second region is positioned at an outermost position of the first side surface in a direction in which the pair of side surfaces opposes each other, and
the fourth region is positioned at an outermost position of the second side surface in the direction in which the first and second side surfaces oppose each other.
